(19) United States
(12) Patent Application Publication
(10) Pub. No.: US 2012/0162432 A1
(43) Pub. Date: Jun. 28, 2012

(54) METHOD FOR CAPTURING IMAGES OF VEHICLES

(75) Inventors: Alexander Abl, Viktring (AT); Jasja Tijink, Breitenfurt (AT); Oliver Nagy, Wien (AT)

(73) Assignee: KAPSCH TRAFFICCOM AG, Wien (AT)

(21) Appl. No.: 13/330,379

(22) Filed: Dec. 19, 2011

(30) Foreign Application Priority Data
Dec. 27, 2010 (EP) 10 450 197.8

(51) Int. Cl. H04N 7/18

(52) U.S. Cl. 348/149; 348/E07.085

(57) ABSTRACT

A method for capturing images of vehicles at excessive speeds including: generating a random access identifier for and capturing an image of the vehicle at the entry and storing them in a first memory which can only be accessed via the access identifier, recording the entry time and an entry identifier at the entry, forming an encrypted or hashed value of the entry identifier and storing the entry time, the value and the access identifier as a data set in a second memory, recording the exit time and an exit identifier at the exit, forming an encrypted or hashed value of the exit identifier and ascertaining the data set with it from the second memory. If the exit time lies within a preset time span from the entry time, using the access identifier for accessing the first memory to retrieve the stored entry image of the vehicle.

### CROSS-REFERENCE TO RELATED APPLICATION(S)

This application claims priority to European Patent Application No. 10 450 197.8, filed on Dec. 27, 2010, the contents of which are hereby expressly incorporated by reference.

### FIELD OF THE INVENTION

The present invention relates to a method for capturing images of vehicles travelling through a section between an entry and an exit at excessive speeds.

### BACKGROUND

Certain traffic control tasks require capturing an image of a vehicle for collecting evidence for the punishment of traffic offences. An example for this is what is called “Section Control”, where the entry and exit times of a vehicle are measured on a section of road, which the vehicle has passed, and utilised to determine the speed. Traffic monitoring systems used for this purpose must comply with strict data protection requirements in order to prevent, as far as possible, the generation of invalid movement profiles of road users. For example, legal regulations in Austria and Germany relating to Section Control require that permanent identification of a vehicle and its passing-through data permitted only if the vehicle has exceeded a speed limit.

Systems known up to now attempt to fulfil these data protection requirements in such a way that if no traffic offence has been committed following identification of the vehicle at the entry and exit and the resulting speed measurement, all recorded data are deleted without trace within a guaranteed period of time, for example within 8 minutes (see F. Albrecht, “Section Control in Germany”, Road Traffic Act, journal for lawyers specialising in road traffic matters, 2009). This approach continues to suffer from uncertainties because all passing-through data exist in unencrypted form at the entry and exit stations at a certain point in time, irrespective of whether an offence had been committed or not.

Further solutions are described in the following publications: DE 10 2007 059 346 A1, DE 10 2005 036 562 A1, EP 0 978 811 A2, U.S. Pat. No. 6,081,206 and AT 8939 U1. All these known systems are cumbersome or cannot remove with any certainty the risk of data misuse or any concerns regarding data protection.

### SUMMARY

The present invention is directed to a method for capturing images of vehicles passing through a section of road at excessive speed, which offers maximum data protection for the sensitive passing-through data.

In some embodiments, the present invention is a method for capturing images of vehicles passing through a section between an entry and an exit at excessive speeds. The method includes: generating a random access identifier for a vehicle passing the entry; capturing an entry image of the vehicle at the entry and storing the entry image and the random access identifier in a first memory. The first memory is accessible only via the random access identifier. The method further includes: recording an entry time and at least one entry identifier of the vehicle at the entry, forming an encrypted or hashed value of the entry identifier, and storing the entry time, the encrypted or hashed value and the random access identifier as a data set in a second memory; recording an exit time and at least one exit identifier of the vehicle at the exit, forming an encrypted or hashed value of the exit identifier, and ascertaining a data set which has the same encrypted or hashed value from the second memory; and if the exit time lies within a preset first time span from the entry time of said data set, using the random access identifier from said data set for accessing the first memory to retrieve the stored entry image of the vehicle.

In some embodiments of the present invention, an exit image of the vehicle is preferably additionally captured, then used to ascertain a vehicle class and the first time span is preset depending upon the ascertained vehicle class. This allows different speed limits for different classes (types) of vehicles to be checked, for example 130 km/h for private cars, 100 km/h for lorries, 80 km/h for vehicles with trailers etc.

In a further embodiment of the invention, the entry images in the first memory are provided with their respective capturing time, and each entry image which is not retrieved within a predefined second time span is deleted. The time for storing the image data in the first memory is therefore limited to the minimum time required which further reduces the risk of manipulation and unauthorised data access.

In some embodiments, in cases where the exit time does not fall within the first time span from the entry time of the data set, the access identifier from this data set is used for deleting the associated entry image stored in the first memory.

In some embodiments, the first memory is physically separated from the second memory in order to make it easier for the first memory to be set up as a “black box”.

In a further embodiment of the invention, at the exit an exit image of the vehicle is additionally captured and each successfully retrieved entry image is archived together with the exit image and the identifier of the vehicle for evidence. In this way, two-fold evidence of speeding offences can be secured.

The identifier of the vehicle may be any feature of the vehicle suitable for identification purposes, for example a remotely readable undercarriage number, a radio identifier of an accompanying RFID transponder chip etc. In some embodiments, the identifier is simply the registration number on the license plate of the vehicle which is captured in form of a picture or alphanumerically by optical character recognition (OCR) in the entry and exit images of the vehicle. These pictures may be the same entry and exit images which are archived for evidence thus requiring only a single picture to be taken at the entry and the exit.

Moreover, the entry and exit times of a vehicle may be used along with the length of the section between the entry and exit to simultaneously also ascertain its speed.

Optionally, the access to the captured images may be additionally checked by carrying out a further offence check within the first memory (the “black box”) which involves the entry and exit stations transferring the entry and exit times along with the access identifier to the black box in an electronically signed form. Accordingly, the respective images and the entry and exit times are provided with an electronic signature of an entry and exit station, and in particular, the entry and exit times are provided to the first memory when this memory is accessed, whereby the first memory will allow retrieval of the entry image only if the entry and exit times provided in conjunction therewith fall within the first time span, wherein preferably the first memory would also check the signatures of the entry and exit times.

According to a further embodiment, the entry and exit images may be made available in the respective memories encrypted with a special key by a third party such as a responsible traffic control authority, so that this third party, in particular the authority, can carry out control checks.

### BRIEF DESCRIPTION OF THE DRAWINGS

FIG. 1 is a schematically drawn overview of a section control system operating according to some embodiments of the invention; and

FIG. 2 is the method according to some embodiments of the invention in the form of a sequence diagram.

### DETAILED DESCRIPTION

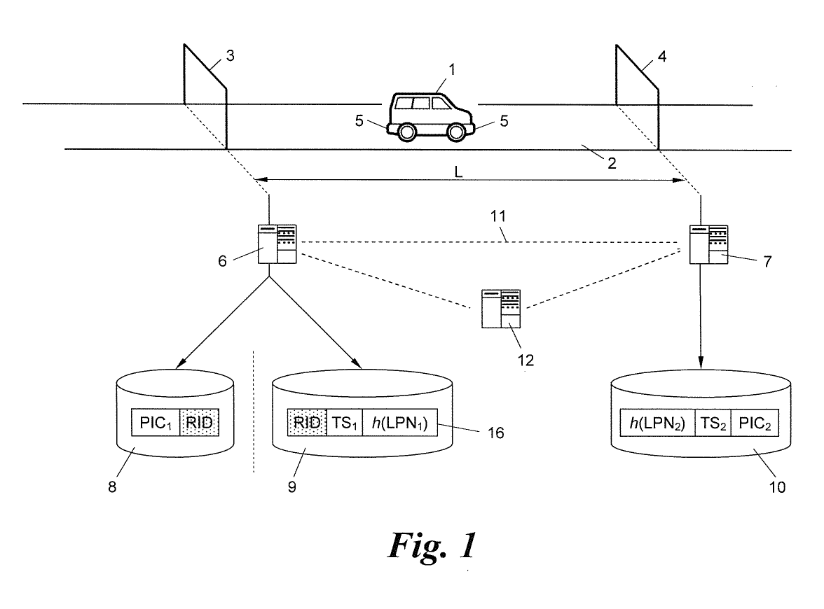

FIG. 1 shows a vehicle 1 passing through a section 2 of length L from an entry 3 to an exit 4. The vehicle 1 has an unequivocal identifier 5, for example in the form of a license plate number LPN. Alternatively the identifier 5 may be formed by other features of vehicle 1, for example by a machine-readable undercarriage number, a remotely readable radio identifier, for example an RFID identifier etc.

At the entry and exit 3, 4 schematically drawn respective entry and exit stations 6, 7 are arranged. Entry station 6 includes at least one photographic or video camera which is capable of capturing an entry image PIC₁ of vehicle 1 and also the entry time TS₁ while the vehicle is passing through entry 3. In addition, the entry station 6 captures the identifier 5 or the LPN of vehicle 1 as the “entry identifier” LPN₁.

The entry identifier LPN₁ may, for example, be captured directly by optical character recognition (OCR) of the vehicle identifier of vehicle 1 in entry image PIC₁, or by remotely reading a radio identifier from a RFID transponder chip or onboard unit (OBU) of vehicle 1 or similar.

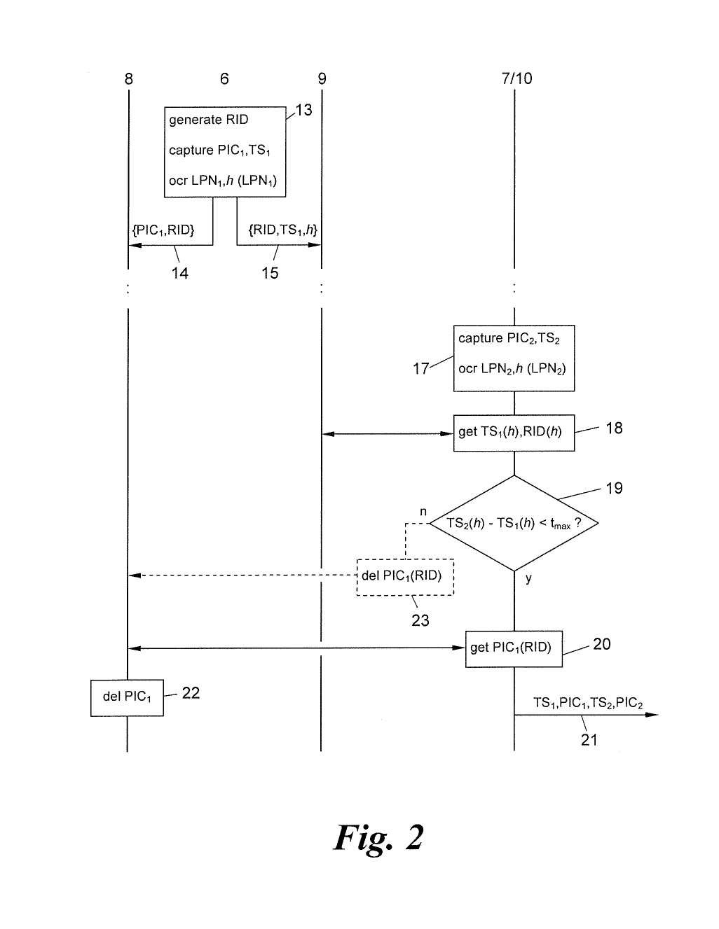

The entry image PIC', the entry identifier LPN₁ and the entry time TS₁ are stored by the entry station 6 in data bases 8, 9 as will be explained in detail later with reference to FIG. 2.

The exit station 7 in turn captures an exit image PIC₂ of vehicle 1 when passing the exit 4 and records the exit time TS₂ as well as the identifier 5 or the LPN of vehicle 1 as the “exit identifier” LPN₂. The exit image PIC₂, the exit identifier LPN₂ and the exit time TS₂ are temporarily stored in an internal memory 10 of exit station 7.

The present invention allows storing of the captured images of the vehicles separately in a safe memory for as long as necessary to have it available in case of traffic offence. During this time the images taken can be accessed only with the aid of a random access identifier, which in turn can only be determined based on an anonymised comparison of the encrypted or hashed entry and exit data. The first memory may for example be sealed in the manner of a “black box” and issued with a data privacy certificate, with the key (access identifier) for the “sealed” captured images made available only in case of a traffic offence.

The “encrypted value” of the entry/exit identifier in the present invention is understood to mean an encryption of this identifier with the aid of a cryptographic key which has to be known in order to decipher the identifier. The “hashed value” (hash value) of the entry/exit identifier in the present description means that a practically irreversible n:1 mapping function has been applied to this identifier, i.e. a function which can be reversed only (extremely) ambiguously so that knowledge of the hash value implies that practically no conclusions can be drawn as to the output value (the identifier). Examples of such hash functions are the checksum function, the modulo function etc.

In some embodiments, the entry and exit times of quasi “anonymous” encrypted or hashed values are compared; and only if these lie within a preset time span, the associated access identifier can be used for retrieving a captured image. The invention thus ensures that pictorial identification of a vehicle is possible only if an offence was committed. The period of time is chosen such that it corresponds to the minimum admissible travelling time for the section, i.e., when a vehicle passes through the section at the maximum admissible speed. Data security is thus essentially increased.

The entry and exit stations 6, 7 may be connected with each other via a data connection 11, and the method described hereunder may, for example, be performed directly in the exit station 7. Alternatively the entry and exit stations 6, 7 may be connected to an evaluation computer 12 in which their data is evaluated in a manner which will now be described.

FIG. 2 shows in detail an exemplary method of the invention performed in conjunction with the components of FIG. 1. In step 13, a unique, unequivocal and random access identifier (random ID) RID is generated at the entry station 6 for each vehicle 1 passing the entry 3. The access identifier RID may be randomly generated or be taken from a list of previously stored random access identifiers, which is known only at the entry station 6. Also in step 13, the entry image LPN₁ and the entry time TS₁ are captured as the entry identifier LPN₁ and are recorded in the described manner, for example by means of OCR evaluation of the entry image PIC₁, as the vehicle identifier of vehicle 1. Then, a hash value h is calculated in step 13 from the entry identifier LPN₁. The hash value h is generated as explained above in a practically irreversible manner, from the entry identifier LPN₁.

In some embodiments, instead of a hash value, an encrypted value of the entry identifier LPN₁ is calculated. This involves using a key which is known only at the entry and exit stations 6, 7. All the explanations made here with reference to hash values also apply to the encrypted values.

In step 14, the entry image PIC₁ is stored under the random access identifier RID in the first memory 8 of the entry station 6. The memory 8 is a separate memory which may physically isolated, sealed and certified (under the data protection act) in the form of a “black box”, from which the once stored entry images PIC₁ can only be retrieved using their respective access identifier RID.

In step 15, the hash value h (LPN₁) is stored together with the entry time TS₁ and the access identifier RID, as the data set 16 in the second memory 9 of the entry station 6.

At a later time, in step 17, a vehicle passes the exit 4, wherein initially it is not certain, whether it is the same vehicle 1 which has passed the entry 3 in steps 13-15. In step 17, the exit station 7 records the exit identifier LPN₂ and the exit time TS₂ as well as the exit identifier LPN₂, which for example may be obtained from an exit image by OCR evaluation of a vehicle identifier recognisable within it. Alternatively or additionally, the exit identifier LPN₂ could be ascertained from a radio identifier or other characteristic feature of the vehicle 1. In this case, capturing an exit image PIC₂ is not obligatory, but may be favourable for the purpose of evidence at a later stage. From the exit identifier LPN₂, the exit station 7 again calculates a hash value h (LPN₂) in the manner explained above.

If at the entry station, an encrypted value was used for the entry identifier LPN₁ instead of a hash value, an encrypted value is also used for the exit identifier LPN₂ at the exit station instead of a hash value, by using the same key (or the other half of a corresponding public/private key pair for the entry and exit station 6, 7).

In step 18, the hash value h of the exit identifier LPN₂ is used to ascertain the data set 16 from the second memory 9 of the entry station 6, which contains the same hash value h as obtained from the entry identifier LPN₁. In this way, the entry time TS₁ and the associated stored access identifier RID belonging to one and the same vehicle 1 may be ascertained without having to exchange the vehicle identifier 5 or LPN directly between the entry and exit stations 6, 7.

When the entry and exit identifiers LPN₁ and LPN₂ are ascertained by OCR from the entry and exit images PIC₁ and PIC₂, because OCR procedures are prone to errors, several different “candidate” identifiers LPN₁ or LPN₂ may be obtained as possible OCR read-out results, instead of a single correct OCR read-out. Based on such multiple candidate identifiers LPN₁ and LPN₂, it is therefore feasible that several encrypted or hashed candidate hash values h are formed on each side, that is, at the entry station and at the exit station. Therefore, during said retrieval of the data set 16 from the memory 9 therefore the different candidate hash values h of both sides are compared with each other, respectively, to identify the “matching” data set 16, in which these hash values h match. Since it is unlikely that the OCR procedures in the entry and exit stations lead to exactly the same read-out errors and thus to the same sets of candidate identifiers and candidate hash values h, it is probable that only one single match is found between the (candidate) hash values h of the two sides. Therefore, in these cases, the method also leads to a correct data set 16.

In step 19, a comparison is carried out as to whether the exit time TS₂ of vehicle 1 lies within a preset time span tₘₐₓ from the entry time TS₁ of the same vehicle 1. If this is the case (branch “y” of comparison 19), there is a speeding offence. That is, vehicle 1 has driven through section L in a shorter time than the admissible time tₘₐₓ which means it has passed through it at a higher than admissible maximum speed. In this case, the black box memory 8 is accessed in step 20, using the access identifier RID indicated in the data set 16, in order to retrieve from it the entry image PIC₁ stored under the access identifier RID. The entry image PIC₁ may be used directly for punishment (enforcement) of the traffic offence, or it may be archived in an optional step 21 together with the entry and exit times TS₁, TS₂ and the optional exit image PIC₂, in a memory such as, memory 10 of the exit station 7.

The time tₘₐₓ may also be preset depending upon the type (class) of vehicle 1. To this end, the exit image PIC₂ of the vehicle 1 may be automatically analysed in order to classify the vehicle 1. Depending upon the classification result, different time spans tₘₐₓ can then be determined from a stored table and specified to define certain speed limits for certain vehicle types, taking into account the length L of section 2, for example 130 km/h for private cars, 100 km/h for lorries, 80 km/h for vehicles with trailers, etc.

A computer (not shown) can retrieve the data generated in step 21 for further enforcement and following the retrieval, all data may be deleted from the exit station 7 and the memory 10.

The black box memory 8 (and optionally also the second memory 9) may be designed in such a way that all the entry images PIC₁ (or optionally also the data TS₁, h(LPN₁)) are continually deleted from it, in the case they are not retrieved after a preset time span from the time TS₁ of their capture, for example, after the said time span tₘₐₓ. Since these “non retrieved” entry images PIC₁ are images of vehicles 1 which have not committed a traffic offence, and therefore they are deleted for following expiry of the time span tₘₐₓ (step 22). To this end, the image-capturing or entry times TS₁ may be stored directly in the first memory 8 together with the entry images PIC₁.

Alternatively, deletion of the no-offence entry images PIC₁ from the first memory 8 (and optionally deletion of the data from the second memory 9) may be initiated by the entry station 6, using the entry times TS₁ from the second memory 9, if the actual time is greater than the entry time TS₁ plus the time span tₘₐₓ.

A further alternative is illustrated in optional step 23 which is passed through at the “no” branch of comparison 19. Deletion of the no-offence entry images PIC₁ is initiated in step 23 by the exit station 7 which sends a request to the black box memory 8 (and optionally to the second memory 9), or the entry station 6 to delete the entry image (and optionally the data in memory 9). Thus, a vehicle conforming to the rules does not leave any identifiable trace in the system thereby achieving maximum data security.

Steps 17 to 21, or 23 of the invention that are normally carried out in the exit station 7 may instead be carried out in the (optional) evaluation computer 12 with the exception of recording the exit time TS₂ and the exit image PIC₂.

Optionally, the entry and exit images PIC₁ and PIC₂ may be encrypted with a key by an authority and made available in the respective memories 8, 9, 10 for control checks by the authority.

It will be recognized by those skilled in the art that various modifications may be made to the illustrated and other embodiments of the invention described above, without departing from the broad inventive scope thereof. It will be understood therefore that the invention is not limited to the particular embodiments or arrangements disclosed, but is rather intended to cover any changes, adaptations or modifications which are within the scope and spirit of the invention as defined by the appended claims.

What is claimed is:

1. A method for capturing images of vehicles passing through a section between an entry and an exit at excessive speeds, the method comprising:
generating a random access identifier for a vehicle passing the entry;
capturing an entry image of the vehicle at the entry and storing the entry image and the random access identifier in a first memory, wherein the first memory is accessible only via said random access identifier;
recording an entry time and at least one entry identifier of the vehicle at the entry, forming an encrypted or hashed value of said entry identifier, and storing the entry time, the encrypted or hashed value and the random access identifier as a data set in a second memory;
recording an exit time and at least one exit identifier of the vehicle at the exit, forming an encrypted or hashed value of the exit identifier, and ascertaining a data set which has the same encrypted or hashed value from the second memory; and
if the exit time lies within a preset first time span from the entry time of said data set, using the random access identifier from said data set for accessing the first memory to retrieve the stored entry image of the vehicle.

2. The method according to claim 1, further comprising:
capturing an exit image of the vehicle and a vehicle class ascertained from the exit image; and
presetting the first time span depending upon the ascertained class.

3. The method according to claim 1, wherein the entry image in the first memory is provided with its capturing time and if the entry image is not retrieved within a second preset time span from said capturing time, the entry image is deleted from the first memory.

4. The method according to claim 1, wherein if the exit time does not fall within the first time span from the entry time of the data set, the access identifier from the data set is used to delete the entry image stored in the first memory.

5. The method according to claim 1, wherein the first memory is physically separated from the second memory.

6. The method according to claim 1, wherein at the exit, an exit image of the vehicle is captured and each successfully retrieved entry image is archived together with the exit image and the identifier of the vehicle.

7. The method according to claim 1, wherein a license plate number of the vehicle is used as the entry and exit identifiers, wherein the license plate number is captured by optical character recognition in entry and exit images of the vehicle.

8. The method according to claim 1, wherein the speed of the vehicle is ascertained from the entry and exit times of the vehicle and the length of the section between the entry and exit.

9. The method according to claim 1, wherein at the entry and exit, respective entry and exit images and entry and exit times are provided with an electronic signature of an entry/exit station.

10. The method according to claim 1, wherein when the first memory is accessed, the entry and exit times are provided to the first memory and retrieval of the entry image is allowed only if the entry and exit times fall within the first time span.

11. The method according to claim 9, wherein the signatures of the entry and exit times are checked when accessing the first memory.

12. The method according to claim 1, wherein entry and exit images are made available in the first and second memories, respectively, for control checks after having been encrypted with a special key.
